(19) United States
(12) Patent Application Publication
(10) Pub. No.: US 2012/0219036 A1
(43) Pub. Date: Aug. 30, 2012

(54) USING MULTIPLE ANTENNAS TO IMPROVE RANGING AVAILABILITY

(75) Inventors: Edward Harrison Teague, San Diego, CA (US); David Jonathan Julian, San Diego, CA (US); Rinat Burdo, Mevaseret Zion (IL)

(73) Assignee: QUALCOMM Incorporated, San Diego, CA (US)

(21) Appl. No.: 13/406,355

(22) Filed: Feb. 27, 2012

Related U.S. Application Data
(60) Provisional application No. 61/447,448, filed on Feb. 28, 2011.

(51) Int. Cl. H04B 7/02; H04B 1/69; H01Q 1/27

(52) U.S. Cl. 375/141; 343/718; 455/66.1; 375/E01.001

(57) ABSTRACT

Certain aspects of the present disclosure relate to a technique for multiple antennas on a body-mounted node to improve ranging availability. The present disclosure also supports utilizing transmit antenna diversity for reliable ranging, wherein the antenna diversity can be achieved by employing two separate transmitter chains.

### CLAIM OF PRIORITY UNDER 35 U.S.C. §119

The present Application for Patent claims benefit of U.S. Provisional Patent Application Ser. No. 61/447,448, entitled, “Using multiple antennas to improve ranging availability”, filed Feb. 28, 2011 and assigned to the assignee hereof and hereby expressly incorporated by reference herein.

### BACKGROUND

1. Field

Certain aspects of the present disclosure generally relate to signal processing and, more particularly, to a method and apparatus for utilizing multiple antennas on a body-mounted node to improve ranging availability.

2. Background

Body tracking systems have been progressing on two different fronts. First, professional grade “motion capture” systems are available that can capture motion of an actor, athlete, player, etc. with high fidelity for use by movie and game studios, for example. These systems are typically high-cost, and thus not suitable for consumer grade applications.

Second, living room game controllers have progressed recently from being based on button presses, to being based on player movement. Since these are consumer products, the technology is much lower cost, and in general, much lower in performance as well. For example, in the NINTENDO® Wii system, low-cost inertial sensors can detect hand motion which is used to control the game play. Issues with the accuracy of this type of game control have driven the rise in camera-based motion capture using camera augmentation systems. For example, the SONY® Move system can use a camera to track a spherical feature on the handheld game controller; this input can be combined with inertial sensor data to detect motion. Furthermore, the MICROSOFT® Kinect system is capable of removing the controller entirely and can use a combination of traditional and depth detecting cameras to detect the body motion utilizing these cameras alone.

There are two primary classes of problems with the current technology. First, these systems suffer from performance issues that limit the types of motions that are detectable and that limit the types of games and user interactions that are possible (for example, camera systems only work on things that are in the field of view of the camera, and that are not blocked by objects or people). Second, the camera augmentation systems are constrained to being operated in an enviromnent where a stationary camera can be mounted and installed—most commonly in the living room.

Therefore, technology advances are desired to enable improvements in consumer grade body tracking performance and to enable these systems to go wherever the user wants to go. Example applications include mobile gaming between one or more players, and sports performance tracking and training (outdoor or in the gym). Further, there are many more potential applications for mobile body tracking that may emerge if such tracking technology is available at consumer prices.

### SUMMARY

Certain aspects of the present disclosure provide an apparatus mountable on a body. The apparatus generally includes a plurality of antennas distributed about the apparatus, first circuitry configured to communicate signals with another apparatus, and second circuitry configured to select one or more of the antennas based on a detected presence or absence of signal occlusion when communicating signals with the other apparatus and to obtain range information utilizing the communicated signals using the selected one or more antennas.

Certain aspects of the present disclosure provide a method for wireless communications. The method generally includes communicating signals between an apparatus and another apparatus, wherein the apparatus is mountable on a body and comprises a plurality of antennas distributed about the apparatus, and selecting one or more of the antennas based on a detected presence or absence of signal occlusion when communicating signals with the other apparatus and obtaining range information utilizing the communicated signals using the selected one or more antennas.

Certain aspects of the present disclosure provide an apparatus for wireless communications. The apparatus generally includes means for communicating signals between an apparatus and another apparatus, wherein the apparatus is mountable on a body and comprises a plurality of antennas distributed about the apparatus, and means for selecting one or more of the antennas based on a detected presence or absence of signal occlusion when communicating signals with the other apparatus and obtaining range information utilizing the communicated signals using the selected one or more antennas.

Certain aspects of the present disclosure provide a computer-readable medium. The computer-readable medium is generally encoded with instructions executable to communicate signals between an apparatus and another apparatus, wherein the apparatus is mountable on a body and comprises a plurality of antennas distributed about the apparatus, and select one or more of the antennas based on a detected presence or absence of signal occlusion when communicating signals with the other apparatus and obtaining range information utilizing the communicated signals using the selected one or more antennas.

Certain aspects of the present disclosure provide a user device mountable on a body. The user device generally includes a plurality of antennas distributed about the user device, first circuitry configured to communicate signals with another device, second circuitry configured to select one or more of the antennas based on a detected presence or absence of signal occlusion when communicating signals with the other device and to obtain range information utilizing the communicated signals using the selected one or more antennas, and an interface configured to display an indication based on the communicated signals.

Certain aspects of the present disclosure provide a sensing device mountable on a body. The sensing device generally includes a sensor configured to generate sensed data, a plurality of antennas distributed about the sensing device, first circuitry configured to communicate the sensed data with another device, and second circuitry configured to select one or more of the antennas based on a detected presence or absence of signal occlusion when communicating the sensed data with the other device and to obtain range information utilizing the communicated sensed data using the selected one or more antennas.

### BRIEF DESCRIPTION OF THE DRAWINGS

So that the manner in which the above--recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG, 1 illustrates an example of mobile body motion capture with ranging within a body area network (BAN) in accordance with certain aspects of the present disclosure.

FIG, 2 illustrates various components that may be utilized in a wireless device of the BAN in accordance with certain aspects of the present disclosure.

FIG. 3 illustrates an example of transmit chain of the wireless device in accordance with certain aspects of the present disclosure.

FIG. 4illustrates example operations that may be performed at a body-mounted node in accordance with certain aspects of the present disclosure.

FIG. 4A illustrates example components capable of performing the operations illustrated in FIG. 4.

### DETAILED DESCRIPTION

Various aspects of the disclosure are described more fully hereinafter with reference to the accompanying drawings. This disclosure may, however, be embodied in many different forms and should, not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should, appreciate that the scope of the disclosure is intended, to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration,” Any aspect described herein as “exemplary” is not necessarily to be construed as preferred or advantageous over other aspects,

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof

### AN EXAMPLE WIRELESS COMMUNICATION SYSTEM

The techniques described herein may be used for various wireless communication systems, including communication systems that are based on an orthogonal multiplexing scheme and a single carrier transmission. Examples of such communication systems include Orthogonal Frequency Division Multiple Access (OFDMA) systems, Single-Carrier Frequency Division Multiple Access (SC-FDMA) systems, Code Division Multiple Access (CDMA), and so forth. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are created in the frequency domain with OFDM and in the time domain with SC-FDMA. A CDMA system may utilize spread-spectrum technology and a coding scheme where each transmitter user) is assigned a code in order to allow multiple users to be multiplexed over the same physical channel.

The teachings herein may be incorporated into (e.g., implemented within or performed by) a variety of wired or wireless apparatuses (e.g., nodes). In some aspects, a node comprises a wireless node. Such wireless node may provide, for example, connectivity for or to a network (e.g., a wide area network such as the Internet or a cellular network) via a wired or wireless communication link. In some aspects, a wireless node implemented in accordance with the teachings herein may comprise an access point or an access terminal

Certain aspects of the present disclosure may support methods implemented in body area networks (BANS). The BAN represents a concept for continuous body monitoring for motion capture, diagnostic purposes in medicine, and so on.

FIG. 1 illustrates an example 100 of a mobile game between two players, each of whom wears nodes. Each node may determine its distance (i.e., range) from other nodes located on the same player or on the other player. An optional stationary ground node 102 is also displayed in FIG. 1, which might not be mounted on a body but is instead placed at a stationary location. In an aspect of the present disclosure, body-mounted nodes 104 and the stationary node 102 may mutually communicate as being part of a BAN.

Each body-mounted node may comprise a wireless sensor that senses (acquires) one or more signals associated with a body (e.g., an electrocardiogram (ECG) signal, an electroencephalogram (EEG) signal, a 3D-Accelerometer (3D-Accl) signal, etc) and communicates the signals (e.g., over a wireless channel or a communications link 106 illustrated in FIG. 1) to the stationary node (also referred to herein as an estimator) 102 for processing purposes. In an aspect of the present disclosure, a pair of body-mounted nodes may also communicate with each other for range sensing purposes. Range (distance) information generated by the body-mounted nodes 104 may be utilized at the stationary node 102 for estimating motion of the players from FIG. 1.

The BAN from FIG. 1 may be therefore viewed as a wireless communication system where various wireless nodes communicate using either an orthogonal multiplexing scheme or a single carrier transmission. The estimator 102 may be a monitoring device, a Personal Data Assistant (PDA), a mobile handset, a personal computer, etc. In an aspect, the wireless nodes in FIG. 1 may also operate in accordance with compressed sensing (CS), where an acquisition rate may be smaller than the Nyquist rate of a signal being acquired. For example, the body-mounted nodes from FIG. 1 may acquire the signals associated with the body using CS.

As discussed further below, in some aspects the communications link 106 comprises a pulse-based physical layer. For example, the physical layer may utilize ultra-wideband pulses that have a relatively short length (e.g., on the order of a few nanoseconds) and a relatively wide bandwidth. In some aspects, an ultra-wide band may be defined as having a fractional bandwidth on the order of approximately 20% or more and/or having a bandwidth on the order of approximately 500 MHz or more. The fractional bandwidth is a particular bandwidth associated with a device divided by its center frequency. For example, a device according to this disclosure may have a bandwidth of 1.75 GHz with center frequency 8.125 GHz and thus its fractional bandwidth is 1.75/8.125 or 21.5%.

FIG. 2 illustrates various components that may be utilized in a wireless device (wireless node) 202 that may be employed within the system from FIG. 1. The wireless device 202 is an example of a device that may be configured to implement the various methods described herein. The wireless device 202 may correspond to the estimator 102 or to any of the body-mounted nodes 104 from FIG. 1.

The wireless device 202 may include a processor 204 which controls operation of the wireless device 202. The processor 204 may also be referred to as a central processing unit (CPU). Memory 206, which may include both read-only memory (ROM) and random access memory (RAM), provides instructions and data to the processor 204. A portion of the memory 206 may also include non-volatile random access memory (NVRAM). The processor 204 typically performs logical and arithmetic operations based on program instructions stored within the memory 206. The instructions in the memory 206 may be executable to implement the methods described herein.

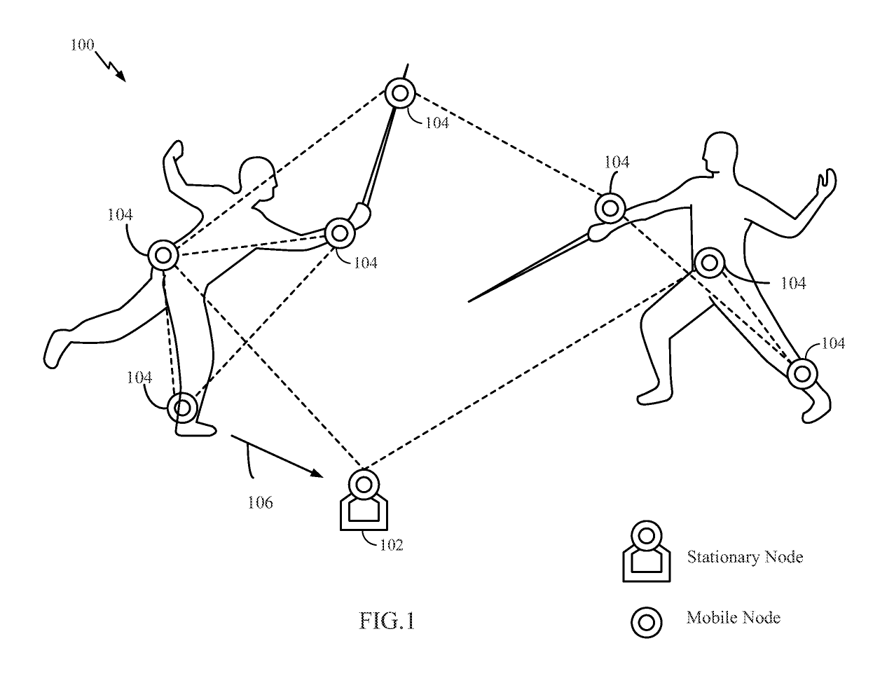

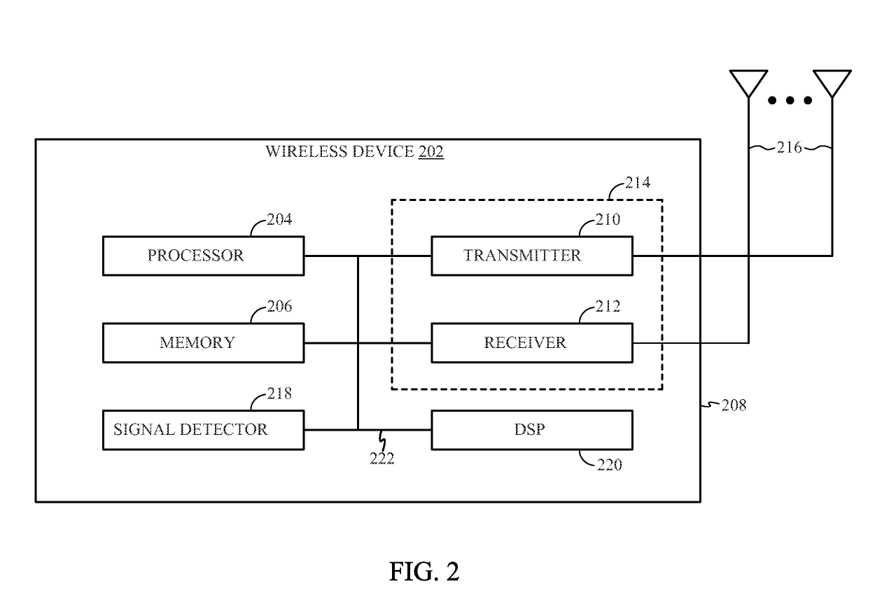

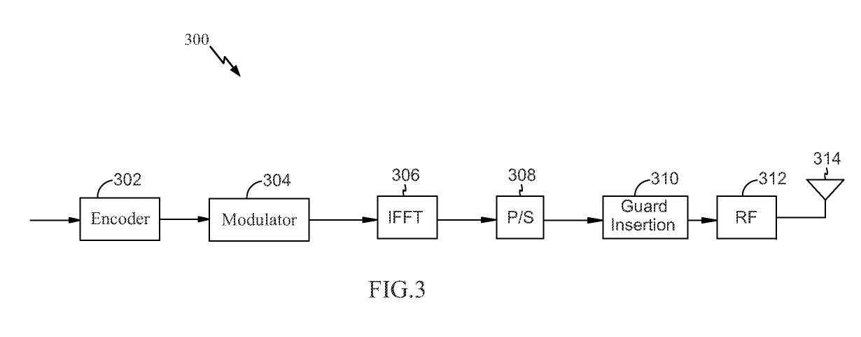

The wireless device 202 may also include a housing 208 that may include a transmitter 210 and a receiver 212 to allow transmission and reception of data between the wireless device 202 and another wireless node (e.g., another wireless node in a remote location). The transmitter 210 and receiver 212 may be combined into a transceiver 214. Wireless device 202 may also include one or more antennas 216 electrically coupled to the transceiver 214. The wireless device 202 may also include (not shown) multiple transmitters, multiple receivers, and/or multiple transceivers. In particular, according to certain aspects, transceiver 214 may include two or more transmit paths 300 (see FIG. 3). In some cases, each transmit path 300 may be coupled to a different one of the antennas 216. Further detail regarding transmit paths is provided below.

The wireless device 202 may also include a signal detector 218 that may quantify the level of signals received by the transceiver 214. The signal detector 218 may quantify detection of such signals using total energy, energy per subcarrier per symbol, power spectral density, and/or other quantification metrics. The wireless device 202 may also include a digital signal processor (DSP) 220 for use in processing signals.

The various components of the wireless device 202 may be coupled by a bus system 222, which may include a power bus, a control signal bus, and a status signal bus in addition to a data bus,

### Mobile Body Tracking

According to certain aspects, mobile body tracking may employ inertial sensors mounted to a body associated with a. BAN. These systems may have limited dynamic range and may be limited by estimator drifts that are common with inertial sensors. Also, acceptable body motion estimation may use a large number of sensor nodes (e.g., a minimum of 15), since each articulated part of the body may need a full orientation estimate. Further, existing systems may need the performance of industrial grade inertial sensors, increasing cost, etc.

For consumers, ease of use and cost are typically of interest. Therefore, it is desirable to develop new methods for reducing the number of nodes required for mobile body tracking while maintaining a desired accuracy.

It should be noted that while the term “body” is used herein, the description can also apply to capturing poses of machines such as robots. Also, the presented techniques may apply to capturing poses of props in an activity, such as swords/shields, skateboards, racquets/clubs/bats, etc.

### Usage of Ranging for Motion Capture

Ranging is a sensing method that determines the distance between two nodes. A body motion estimator may combine ranges with inertial sensor measurements to correct for errors and provide the ability to estimate drift components in the inertial sensors. According to certain aspects, a set of body-mounted nodes may emit transmissions that can be detected with one or more stationary ground reference nodes. The reference nodes may have known positions, and may be time synchronized with each other and with the body-mounted nodes to within a fraction of a nanosecond. However, this system may not be practical for a consumer-grade product due its complex setup requirements. Therefore, further innovation may be desired.

Certain aspects of the present disclosure support mechanisms that allow a system to overcome the limitations of previous approaches and enable products that have the characteristics required for consumer-grade products.

In one aspect of the present disclosure, one node (e.g., a first one of nodes 104 of FIG. 1) may produce range information associated with another node (e.g., a second one of nodes 104 of FIG. 1) based on a signal round-trip-time rather than a time-of-arrival. This may eliminate any clock uncertainty between the two nodes from the range estimate, and thus may remove the requirement to synchronize nodes, which may dramatically simplify the setup. Further, this method makes all nodes essentially the same with respect to synchronization, since there is no concept of “synchronized nodes” versus “unsynchronized nodes.”

This method may determine ranges between any two nodes, including between different body-mounted nodes 104. A stationary node the estimator 102 from FIG. 1) may combine these ranges with inertial sensor data (i.e., measurements obtained by inertial sensors that may be mounted to a body associated with a BAN and that in sonic cases may be part of node 104) and with constraints provided by a kinematic body model to estimate a pose of and/or motion of the body to which the body-mounted nodes are also attached. Whereas the previous system performed ranging only from a body node to a fixed node, removing the time synchronization requirement enables ranging between any two nodes (e.g., two of nodes 104). These additional ranges may be very valuable in a motion tracking estimator due to the additional range data available, and also due to the direct sensing of body relative position. Ranges between nodes on different bodies may be also useful for determining relative position and pose between the bodies.

With the use of high-accuracy round trip time ranges and ranges between nodes both on and off the body, the number and quality of the inertial sensors may be reduced. Reducing the number of nodes may make usage much simpler, and reducing the required accuracy of the inertial sensors may reduce cost. Both of these improvements are desirable in producing a system suitable for consumer products.

### Using Multiple Antennas to Improve Ranging Availability

When range is being determined between nodes where dynamic activity causes periodic occlusions between the nodes, the range measurements may be interrupted or degraded in accuracy due to the occlusions. This may happen in particular when the wireless nodes are mounted on a body (e.g., nodes 104) since motion of the body may cause a node 104 on part of the body to he shadowed or occluded from another node with respect to wireless communication between the two nodes. The loss of range measurements may be detrimental to the operation of a system that depends on these measurements, such as a body motion capture system.

One possible solution for this problem may be to add more nodes in the system. However, this approach may be expensive and may add unnecessary complexity to the overall system. Another solution involves a modification to the existing solution that achieves the required benefit of assuring high availability of ranging measurements in an environment prone to occlusions.

According to one aspect, a node (e.g., a first one of nodes 104 of FIG. 1) may include more than one antenna and the node may determine a range between it and another node (e.g., a second one of nodes 104 of FIG. 1) using signals from more than one of the antennas when the node is occluded with respect to the other node. The multiple antennas may be arranged to minimize the chance that all of the antennas are simultaneously occluded, thereby maximizing availability of range measurements. In an aspect of the present disclosure, one or more of the nodes in the system may include multiple antennas. In one aspect, the multiple antennas connected to a node may be configured as an array of antennas. In this case, each antenna of the array may be connected to a different transmit path (e.g., a transmit path 300 of FIG. 3). In another aspect, the multiple antennas may be configured as a continuous antenna element. The antennas of the continuous antenna element may be connected to a single transmit path (e.g., a transmit path 300 of FIG. 3).

### Using Transmit Antenna Diversity for Reliable Ultra-Wideband Ranging With A Second Transmit Chain

Accurate ranging between two wireless communication devices using impulse-based ultra-wideband (IB-UWB) communication may rely on a line-of-sight (LOS) path between the two devices. However, antennas on wireless devices (especially inexpensive antennas on small devices) may have nulls and/or reduced coverage in certain directions, or polarization differences between the antennas. This may prevent LOS communication and making accurate range measurements.

Certain aspects of the present disclosure support using transmit antenna diversity for reliable ranging (e.g., ranging in accordance with UWB radio technology). In one aspect of the present disclosure, the antenna diversity may be achieved by simultaneously using a second transmit chain along with a first transmit chain. In another aspect, the first transmit chain and the second transmit chain may be used alternately rather than simultaneously.

Each of the first and second transmit chains may be a typical transmit chain 300 illustrated in FIG. 3 comprising, for example, an encoder 302, a modulator 304, an Inverse Fast Fourier Transform (IFFT) block 306, parallel-to-serial (P/S) conversion block 308, a Guard Insertion (GI) block 310, a radio frequency (RE) front-end 312 interfaced with an antenna 314, etc. In an aspect of the present disclosure, the RF front-end 312 may be configured in accordance with the UWB radio technology. It should be noted that duplicating a transmit chain typically occupies much less chip area than if a receive chain was duplicated since the receive chain may usually involve complex detection/decoding schemes.

Further, by duplicating the transmit chain rather than switching between the two antennas at a radio frequency (RF) front-end of transceiver 214, low-cost and low power may be maintained. The switching between antennas may require additional mixed-domain (analog and digital) RF circuitry and very precise control (due to a high switching rate), which may contribute to a substantial cost. In addition, the antenna switching may need to be performed at a high rate (e.g., in accordance with the UWB radio technology), which may contribute to substantial power dissipation at the RF circuitry.

In an aspect of the present disclosure, the second transmit antenna associated with the second transmit chain may be substantially the same as the first transmit antenna, but oriented orthogonally with respect to the first transmit antenna and thus have a different polarization than the first transmit antenna. In another aspect, the second transmit antenna may be a different type of antenna with a different radiation pattern than the first transmit antenna. In this case, the two transmit antennas may not need to be physically distant from each other.

According to certain aspect of the present disclosure. “holes” in the radiation pattern of the first transmit antenna may be filled--in by the radiation pattern of the second transmit antenna. By transmitting a portion of pulses (e.g., UWB based pulses) on a first transmit antenna and other portion of pulses on a second transmit antenna reliable LOS range measurements may be made. In one aspect, the same plurality of pulses may be transmitted on both antennas simultaneously, e.g., using one transmit path 300 or utilizing, as aforementioned for achieving antenna diversity, two transmit paths 300. In another aspect, the same pulses may be transmitted on both antennas, but not simultaneously. For example, the pulses may be transmitted from the first transmit antenna, and then, after a delay, the same pulses may be also transmitted from the second transmit antenna. The first and second transmit antennas may share the same transmit path 300, or they may employ two separate transmit paths 300 for achieving full antenna diversity. In another aspect, different pulses may be transmitted on both antennas, but not simultaneously, e.g., using one transmit path 300 or two transmit paths 300. Each of these pulses may be allocated to a specific transmit antenna (i.e., to the first or second transmit antenna) either deterministically, or according to a pseudo-random sequence. If, for the moment, one of the transmit antennas is known to be occluded, the pulses may only be transmitted from the other (not occluded) transmit antenna. Other diversity solutions might use a half-wavelength or more separating the two antennas. Alternatively, node 104 may achieve transmit diversity using two antennas having dissimilar antenna radiation patterns.

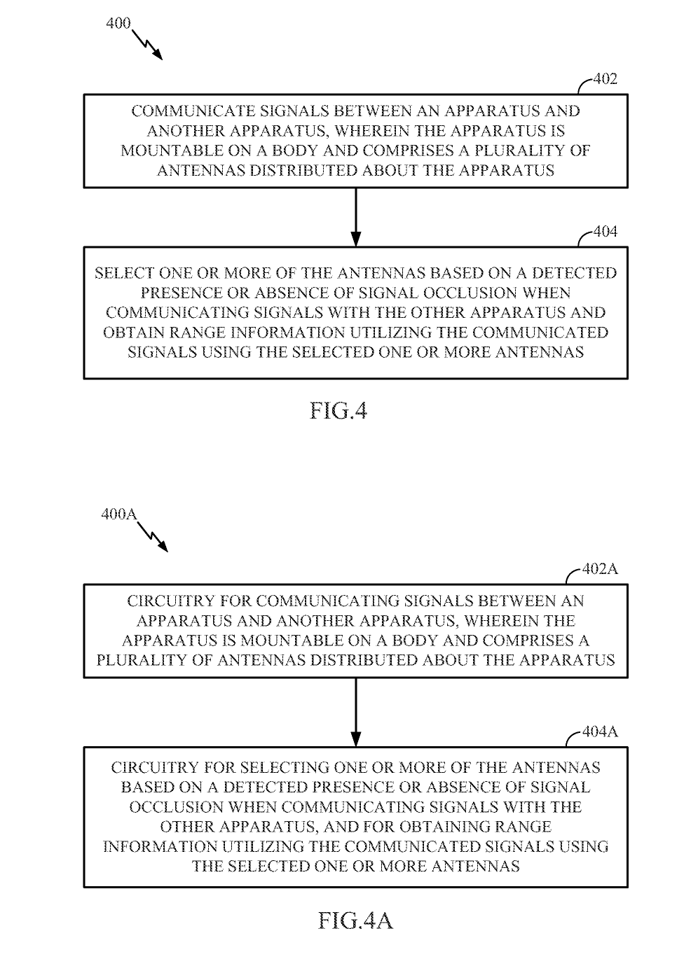

FIG. 4 illustrates example operations 400 that may be performed at a body-mounted wireless node (an apparatus) in accordance with certain aspects of the present disclosure. In an aspect of the present disclosure, a plurality of antennas may be distributed about the apparatus. At 402, the apparatus may communicate signals with another apparatus. At 404, the apparatus may select one or more of the antennas based on a detected presence or absence of signal occlusion when communicating signals with the other apparatus and to obtain range information utilizing the communicated signals using the selected one or more antennas. In an aspect, the one or more selected antennas may be selected for transmitting the signals. In another aspect, the one or more selected antennas may be selected for receiving the signals.

In an aspect, the plurality of antennas may be distributed at the apparatus to reduce a probability of all the antennas being simultaneously occluded when communicating signals with the other apparatus. In one aspect of the present disclosure, the range information may be obtained based on a round-trip time of one of the signals communicated between the apparatus and the other apparatus.

According to certain aspects, the plurality of antennas may comprise two antennas, wherein each of the two antennas may be associated with a different transmit chain 300 of the apparatus. In one aspect, the two antennas may be used to determine the range information using the UWB radio technology. Furthermore, as aforementioned, at least one pulse associated with at least one of the signals being in accordance with the UWB radio technology has a fractional bandwidth of at least about 20%, and/or the at least one UWB pulse has a bandwidth of at least about 500 MHz.

In an aspect, two of the antennas may have different radiation patterns relative to one another. In another aspect, the two antennas may have the same radiation pattern and yet be placed in different locations on the apparatus.

In an aspect, the one or more antennas may be selected based on one or more quantification metrics associated with at least one of the signals communicated with the other apparatus during the detected presence or absence of signal occlusion. The one or more quantification metrics may comprise at least one of a total energy, an energy per subcarrier per symbol, or a power spectral density associated with the at least one signal,

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in Figures, those operations may have corresponding counterpart means-plus-function components with similar numbering. For example, operations 400 illustrated in FIG. 4 correspond to components 400A illustrated in FIG. 4A.

In an aspect of the present disclosure, a plurality of antennas (e.g., antennas 216 of FIG. 2) may be distributed about an apparatus (e.g., node 104). At 402A, first circuitry (e.g., transceiver 214) of Bode 104 may communicate signals with another apparatus (e.g., another instance of node 104). At 404A, second circuitry (e.g., processor 204) of node 104 may select one or more of antennas 216 based on a detected presence or absence of signal occlusion when communicating signals with the other apparatus. Furthermore, processor 204 may obtain range information utilizing the communicated signals using the selected one or more antennas. In an aspect, processor 204 may select the selected antennas for transmitting the signals. In another aspect, processor 204 may select the selected antennas for receiving the signals. Additionally, in some aspects, third circuitry (e,g., processor 204) of node 104 may utilize the range information for estimating motion of a body to which node 104 is coupled.

In an aspect of the present disclosure, the means for communicating may comprise a transceiver, e,g., the transceiver 214 of the wireless device 202 from FIG, 2, The means for selecting may comprise an application specific integrated circuit, e.g., the processor 204 of the wireless device 202. The means for obtaining may comprise an application specific integrated circuit, e.g., the processor 204.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing data in a memory) and the like. Also, “determining” may include resolving, selecting, choosing, establishing and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium, Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media), In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared radio and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized,

it is to be understood that the claims are not limited to the precise configuration and components illustrated above. Various modifications, changes and variations may be made in the arrangement, operation and details of the methods and apparatus described above without departing from the scope of the claims,

A wireless device (a wireless node) in the present disclosure may include various components that perform functions based on signals that are transmitted by or received at the wireless device. A wireless device may also refer to a wearable wireless device. In some aspects the wearable wireless device may comprise a wireless headset or a wireless watch. For example, a wireless headset may include a transducer adapted to provide audio output based on data received via a receiver. A wireless watch may include a user interface adapted to provide an indication based on data received via a receiver. A wireless sensing device may include a sensor adapted to provide data to be transmitted via a transmitter.

A wireless device may communicate via one or more wireless communication links that are based on or otherwise support any suitable wireless communication technology. For example, in some aspects a wireless device may associate with a network. In some aspects the network may comprise a personal area network (e,g., supporting a wireless coverage area on the order of 30 meters) or a body area network (e.g., supporting a wireless coverage area on the order of 10 meters) implemented using ultra-wideband (UWB) radio technology or some other suitable technology. In some aspects the network may comprise a local area network or a wide area network. A wireless device may support or otherwise use one or more of a variety of wireless communication technologies, protocols, or standards such as, for example, CDMA, TDMA, OFDM, OFDMA, WiMAX, and Wi-Fi. Similarly, a wireless device may support or otherwise use one or more of a variety of corresponding modulation or multiplexing schemes. A wireless device may thus include appropriate components (e.g., air interfaces) to establish and communicate via one or more wireless communication links using the above or other wireless communication technologies. For example, a device may comprise a wireless transceiver with associated transmitter and receiver components (e,w., transmitter 210 and receiver 212) that may include various components (e.g., signal generators and signal processors) that facilitate communication over a wireless medium.

The teachings herein may be incorporated into (e.g., implemented within or performed by) a variety of apparatuses (e,g,, devices). For example, one or more aspects taught herein may be incorporated into a phone (e.g., a cellular phone), a personal data assistant (“PDA”) or so-called smart-phone, an entertainment device (e,g., a portable media device, including music and video players), a headset (e,w., headphones, an earpiece, etc.), a microphone, a medical sensing device (e.g., a biometric sensor, a heart rate monitor, a pedometer, an EKG device, a smart bandage, etc.), a user I/O device (e.g., a watch, a remote control, a light switch, a keyboard, a mouse, etc.), an environment sensing device (e.g., a tire pressure monitor), a monitoring device that may receive data from the medical or environment sensing device (e.g., a desktop, a mobile computer, etc.), a point-of-care device, a hearing aid, a set-top box, or any other suitable device. The monitoring device may also have access to data from different sensing devices via connection with a network.

These devices may have different power and data requirements. In some aspects, the teachings herein may be adapted for use in low power applications (e.g., through the use of an impulse based signaling scheme and low duty cycle modes) and may support a variety of data rates including relatively high data rates (e.g., through the use of high-bandwidth pulses).

In some aspects a wireless device may comprise an access device (e,g., an access point) for a communication system. Such an access device may provide, for example, connectivity to another network (e.g., a wide area network such as the Internet or a cellular network) via a wired or wireless communication link. Accordingly, the access device may enable another device (e,g., a wireless station) to access the other network or some other functionality. In addition, it should be appreciated that one or both of the devices may be portable or, in some cases, relatively non-portable. Also, it should be appreciated that a wireless device also may be capable of transmitting and/or receiving information in a non-wireless manner (e.g., via a wired connection) via an appropriate communication interface.

While the foregoing is directed to aspects of the present disclosure, other and further aspects of the disclosure may be devised without departing from the basic scope thereof, and the scope thereof is determined by the claims that follow,

1. An apparatus mountable on a body, comprising:
a plurality of antennas distributed about the apparatus;
first circuitry configured to communicate signals with another apparatus; and
second circuitry configured to select one or more of the antennas based on a detected presence or absence of signal occlusion when communicating signals with the other apparatus and to obtain range information utilizing the communicated signals using the selected one or more antennas.

2. The apparatus of claim 1, wherein the plurality of antennas are distributed to reduce a probability of all the antennas being simultaneously occluded from the other apparatus when communicating signals with the other apparatus.

3. The apparatus of claim 1, wherein the antennas are configured as an array of antennas.

4. The apparatus of claim 1, wherein the antennas are configured as a continuous antenna element.

5. The apparatus of claim 1, wherein the second circuitry is configured to obtain the range information based on a round-trip time of one of the signals communicated between the apparatus and the other apparatus.

6. The apparatus of claim 1, wherein:
the plurality of antennas comprises two antennas,
each of the two antennas is associated with a different transmit chain of the apparatus, and
at least one of the two antennas is selected for transmitting the signals to the other apparatus.

7. The apparatus of claim 6, wherein:
the two antennas are used to determine the range information using ultra-wideband (UWB) radio technology, and
at least one pulse associated with at least one of the signals being in accordance with the UWB radio technology has a fractional bandwidth of at least about 20%, a bandwidth of at least about 500 MHz, or a fractional bandwidth of at least about 20% and a bandwidth of at least about 500 MHz.

8. The apparatus of claim 1, wherein two of the antennas are oriented orthogonally relative to one another.

9. The apparatus of claim 1, wherein two of the antennas have different radiation patterns relative to one another.

10. The apparatus of claim 1, wherein the one or more antennas are selected based on one or more quantification metrics associated with at least one of the signals communicated with the other apparatus during the detected presence or absence of signal occlusion.

11. The apparatus of claim 1, wherein:
the plurality of antennas comprises two antennas, and
a portion of pulses associated with at least one of the signals being in accordance with ultra-wideband (UWB) radio technology is transmitted from a first of the two antennas, and
other portion of pulses associated with at least one of the signals being in accordance with the UWB radio technology is transmitted from a second of the two antennas.

12. The apparatus of claim 11, wherein the portion of pulses and the other portion of pulses comprise a plurality of pulses transmitted simultaneously from the two antennas.

13. The apparatus of claim 11, wherein each of the two antennas is associated with a different transmit chain of the apparatus.

14. A method for wireless communications, comprising:
communicating signals between an apparatus and another apparatus, wherein the apparatus is mountable on a body and comprises a plurality of antennas distributed about the apparatus; and
selecting one or more of the antennas based on a detected presence or absence of signal occlusion when communicating signals with the other apparatus and obtaining range information utilizing the communicated signals using the selected one or more antennas.

15. The method of claim 14, wherein the plurality of antennas are distributed to reduce a probability of all the antennas being simultaneously occluded from the other apparatus when communicating signals with the other apparatus.

16. The method of claim 14, wherein the antennas are configured as an array of antennas.

17. The method of claim 14, wherein the antennas are configured as a continuous antenna element.

18. The method of claim 14, wherein the range information is obtained based on a round-trip time of one of the signals communicated between the apparatus and the other apparatus.

19. The method of claim 14, wherein:
the plurality of antennas comprises two antennas,
each of the two antennas is associated with a different transmit chain of the apparatus, and
at least one of the two antennas is selected for transmitting the signals to the other apparatus.

20. The method of claim 19, wherein:
the two antennas are used to determine the range information using ultra-wideband (UWB) radio technology, and
at least one pulse associated with at least one of the signals being in accordance with the UWB radio technology has a fractional bandwidth of at least about 20%, a bandwidth of at least about 500 MHz, or a fractional bandwidth of at least about 20% and a bandwidth of at least about 500 MHz.

21. The method of claim 14, wherein two of the antennas are oriented orthogonally relative to one another.

22. The method of claim 14, wherein two of the antennas have different radiation patterns relative to one another.

23. The method of claim 14, wherein the one or more antennas are selected based on one or more quantification metrics associated with at least one of the signals communicated with the other apparatus during the detected presence or absence of signal occlusion.

24. The method of claim 14, wherein:
the plurality of antennas comprises two antennas, and
a portion of pulses associated with at least one of the signals being in accordance with ultra-wideband (UWB) radio technology is transmitted from a first of the two antennas, and
other portion of pulses associated with at least one of the signals being in accordance with the UWB radio technology is transmitted from a second of the two antennas.

25. The method of claim 24, wherein the portion of pulses and the other portion of pulses comprise a plurality of pulses transmitted simultaneously from the two antennas.

26. The method of claim 24, wherein each of the two antennas is associated with a different transmit chain of the apparatus.

27. An apparatus for wireless communications, comprising:
means for communicating signals between an apparatus and another apparatus, wherein the apparatus is mountable on a body and comprises a plurality of antennas distributed about the apparatus; and
means for selecting one or more of the antennas based on a detected presence or absence of signal occlusion when communicating signals with the other apparatus and obtaining range information utilizing the communicated signals using the selected one or more antennas.

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. A computer-readable medium encoded with instructions executable to:
communicate signals between an apparatus and another apparatus, wherein the apparatus is mountable on a body and comprises a plurality of antennas distributed about the apparatus; and
select one or more of the antennas based on a detected presence or absence of signal occlusion when communicating signals with the other apparatus and obtaining range information utilizing the communicated signals using the selected one or more antennas.

41. A user device mountable on a body, comprising:
a plurality of antennas distributed about the user device;
first circuitry configured to communicate signals with another device;
second circuitry configured to select one or more of the antennas based on a detected presence or absence of signal occlusion when communicating signals with the other device and to obtain range information utilizing the communicated signals using the selected one or more antennas; and
an interface configured to display an indication based on the communicated signals.

42. A sensing device mountable on a body, comprising:
a sensor configured to generate sensed data;
a plurality of antennas distributed about the sensing device;
first circuitry configured to communicate the sensed data with another device; and
second circuitry configured to select one or more of the antennas based on a detected presence or absence of signal occlusion when communicating the sensed data with the other device and to obtain range information utilizing the communicated sensed data using the selected one or more antennas.
